(19) United States
(12) Patent Application Publication
(10) Pub. No.: US 2022/0033294 A1
(43) Pub. Date: Feb. 3, 2022

(54) METHOD FOR MANUFACTURING GLASS FINE PARTICLE DEPOSIT AND METHOD FOR MANUFACTURING GLASS BASE MATERIAL

(71) Applicant: SUMITOMO ELECTRIC INDUSTRIES, LTD., Osaka-shi, Osaka (JP)

(72) Inventors: Masatoshi HAYAKAWA, Osaka-shi, Osaka (JP); Masumi ITO, Osaka-shi, Osaka (JP); Tatsuya KONISHI, Osaka-shi, Osaka (JP); Shuhei TOYOKAWA, Osaka-shi, Osaka (JP)

(73) Assignee: SUMITOMO ELECTRIC INDUSTRIES, LTD., Osaka-shi, Osaka (JP)

(21) Appl. No.: 17/275,769

(22) PCT Filed: Sep. 13, 2019
(86) PCT No.: PCT/JP2019/036201

§ 371 Date: Mar. 12, 2021

(30) Foreign Application Priority Data
Sep. 14, 2018 (JP) 2018-172541

(51) Int. Cl. C03B 37/018

(52) U.S. Cl. CPC C03B 37/01807; C03B 37/01853

(57) ABSTRACT

A method for manufacturing a glass fine particle deposit includes: emitting a siloxane gas, a carrier gas, and a combustion gas from a burner; setting volume concentration of a supply volume amount of the siloxane gas per unit time with respect to the sum of the supply volume amount of the siloxane gas per unit time and a supply volume amount of the carrier gas per unit time (C1) to 10.6 volume %<C1<20.0 volume %; and setting volume concentration of the supply volume amount of the siloxane gas per unit time with respect to the sum of the supply volume amount of the siloxane gas per unit time, the supply volume amount of the carrier gas per unit time, and a supply volume amount of the seal gas per unit time (C2) to 5.8 volume %<C2<10.0 volume %.

### TECHNICAL FIELD

The present disclosure relates to a method for manufacturing a glass fine particle deposit and a method for manufacturing a glass base material.

This application is based upon and claims the benefit of priority from Japanese Patent Application No. 2018-172541, filed on Sep. 14, 2018, the entire contents of which are incorporated herein by reference.

### BACKGROUND ART

Patent Literature 1 describes a method for manufacturing a glass base material including a transparency step of manufacturing a transparent glass base material by manufacturing a glass fine particle deposit using siloxane as a raw material for glass synthesis and by heating the manufactured glass fine particle deposit.

Patent Literature 2 describes that an inert carrier gas and a combustible gas are added when a raw material compound for glass synthesis such as an organosilicon compound is vaporized.

### CITATION LIST

### Patent Literature

Patent Literature 1: JP-A-2015-113259

Patent Literature 2: JP-A-2017-197402

### SUMMARY OF INVENTION

A method for manufacturing a glass fine particle deposit of the present disclosure is a method for manufacturing a glass fine particle deposit, including installing a starting rod and a burner for generating a glass fine particle in a reaction vessel, introducing a siloxane gas which is a glass raw material into the burner, generating the glass fine particle by oxidizing the glass raw material in a flame formed by the burner, and depositing the generated glass fine particle on the starting rod, and the method includes: emitting the siloxane gas and a carrier gas from a center of the burner; emitting a seal gas from an outside in a radial direction of an emission port of the siloxane gas and the carrier gas; emitting a combustion gas from an outside in a radial direction of an emission port of the seal gas; setting volume concentration of a supply volume amount of the siloxane gas per unit time with respect to the sum of the supply volume amount of the siloxane gas per unit time and a supply volume amount of the carrier gas per unit time (C1) to 10.6 volume %<C1<20.0 volume %; and setting volume concentration of the supply volume amount of the siloxane gas per unit time with respect to the sum of the supply volume amount of the siloxane gas per unit time, the supply volume amount of the carrier gas per unit time, and a supply volume amount of the seal gas per unit time (C2) to 5.8 volume %<C2<10.0 volume %.

A method for manufacturing a glass base material of the present disclosure includes heating and sintering a glass fine particle deposit manufactured by the method for manufacturing the glass fine particle deposit.

### BRIEF DESCRIPTION OF DRAWINGS

FIG. 1 is a configuration diagram illustrating one form of a device for manufacturing a glass fine particle deposit according to one aspect of the present disclosure.

FIG. 2 is a configuration diagram illustrating one form of a device for performing a transparency step of a method for manufacturing a glass base material according to one aspect of the present disclosure.

FIG. 3 is a graph illustrating a relationship between a numerical range of supply volume concentration of a siloxane gas with respect to the sum of a carrier gas and the siloxane gas (C1) and supply volume concentration of the siloxane gas with respect to the sum of the carrier gas, a seal gas, and the siloxane gas (C2), and a generation state of a black glass fine particle.

FIG. 4 is a graph illustrating a relationship between the numerical range of the supply volume concentration of the siloxane gas with respect to the sum of the carrier gas and the siloxane gas (C1) and the supply volume concentration of the siloxane gas with respect to the sum of the carrier gas, the seal gas, and the siloxane gas (C2), and a synthesis yield of the glass fine particle.

### DESCRIPTION OF EMBODIMENTS

### Technical Problem to be Solved by the Present Disclosure

In the method as described in Patent Literature 1, when a glass fine particle deposit is manufactured by using siloxane as a raw material for glass synthesis, a deposited glass fine particle may turn black. When the glass fine particle deposit containing the blackened glass fine particle (hereinafter, also referred to as a “black glass fine particle”) is heated and sintered, a void may be generated in an obtained glass base material. When the void is generated in the glass base material manufactured for an optical fiber, the optical fiber can be broken or a cavity can be formed in the optical fiber in a subsequent drawing step. Therefore, a portion where the void is generated is discarded, such that a yield deteriorates.

Since silicon dioxide (SiO₂), which is a main component of the glass fine particle, is white, the glass fine particle also becomes white when SiO₂ has purity of 100%. On the other hand, silicon monoxide (SiO) is brown and black. Accordingly, it is assumed that the reason why the generated glass fine particle turns black when siloxane is used as a glass raw material is because insufficiently oxidized silicon oxide (SiOₓ, X<2) produced as a by-product is contained therein. Therefore, it is considered that the reason why the void is generated in the glass base material obtained by heating and sintering a deposit containing the black glass fine particle is because insufficiently oxidized silicon oxide is contained therein.

As a result of examining a cause of the generation of the black glass fine particle, it is speculated that high concentration of a supply amount of siloxane, which is the raw material for glass synthesis, is one of the causes. Considering the examination result, the generation of the black glass fine particle can be prevented by lowering the concentration of the supply amount of siloxane which is the raw material for glass synthesis. However, it is also found out that when the concentration of the supply amount of siloxane, which is the raw material for glass synthesis, is lowered, a synthesis yield of the glass fine particle is also lowered.

An object of the present disclosure is to provide a method for manufacturing a glass fine particle deposit in which generation of a black glass fine particle can be prevented and a synthetic yield of a glass fine particle can also be sufficiently improved when siloxane is used as a raw material for glass synthesis, and a method for manufacturing a glass base material having a little possibility of generating a void in the glass base material.

### Advantageous Effect of the Present Disclosure

According to the present disclosure, in manufacturing of a glass fine particle deposit using siloxane as a raw material for glass synthesis, it is possible to prevent generation of a black glass fine particle and also sufficiently improve a synthetic yield of a glass fine particle. According to the present disclosure, it is possible to reduce a possibility of generating a void in a glass base material in manufacturing of the glass base material.

### Description of Embodiments of the Present Disclosure

First, contents of embodiments of the present disclosure will be listed and described.

(1) A method for manufacturing a glass fine particle deposit according to one aspect of the present disclosure is a method for manufacturing a glass fine particle deposit including installing a starting rod and a burner for generating a glass fine particle in a reaction vessel, introducing a siloxane gas which is a glass raw material into the burner, generating the glass fine particle by oxidizing the glass raw material in a flame formed by the burner, and depositing the generated glass fine particle on the starting rod, and the method includes: emitting the siloxane gas and a carrier gas from a center of the burner, emitting a seal gas from an outside in a radial direction of an emission port of the siloxane gas and the carrier gas, and emitting a combustion gas from an outside in a radial direction of an emission port of the seal gas; setting volume concentration of a supply volume amount of the siloxane gas per unit time with respect to the sum of the supply volume amount of the siloxane gas per unit time and a supply volume amount of the carrier gas per unit time (C1) to 10.6 volume %<C1<20.0 volume %; and setting volume concentration of the supply volume amount of the siloxane gas per unit time with respect to the sum of the supply volume amount of the siloxane gas per unit time, the supply volume amount of the carrier gas per unit time, and a supply volume amount of the seal gas per unit time (C2) to 5.8 volume %<C2<10.0 volume %.

According to the configuration, in manufacturing of the glass fine particle deposit using siloxane as a raw material for glass synthesis, generation of a black glass fine particle can be prevented and a synthetic yield of the glass fine particle can also be sufficiently improved.

(2) It is desirable that a flow velocity of a mixed gas of the siloxane gas and the carrier gas at the emission port of the burner is set to be equal to or higher than 5 m/s and equal to or lower than 50 m/s.

According to the configuration, since the reaction time for oxidizing siloxane to form glass can be sufficiently taken, the generation of the black glass fine particle can be further prevented, and the synthesis yield of the glass fine particle can be further improved.

(3) It is desirable that a synthesis rate of the glass fine particle is equal to or greater than 0.0000167 kg/s and equal to or less than 0.00067 kg/s, and a synthesis yield of the glass fine particle is equal to or greater than 30%.

According to the configuration, the glass fine particle deposit can be manufactured with higher efficiency.

(4) A method for manufacturing a glass base material according to one aspect of the present disclosure includes heating and sintering a glass fine particle deposit manufactured by any one of the above methods (1) to (3).

According to the configuration, the glass base material having less voids can be manufactured.

### Details of Embodiments of the Present Disclosure

[Overview of Device to be Used]

Hereinafter, examples of embodiments of a method for manufacturing a glass fine particle deposit and a method for manufacturing a glass base material for a glass fiber (hereinafter, also simply referred to as a “glass base material”) according to the embodiment of the present disclosure will be described with reference to the accompanying drawings.

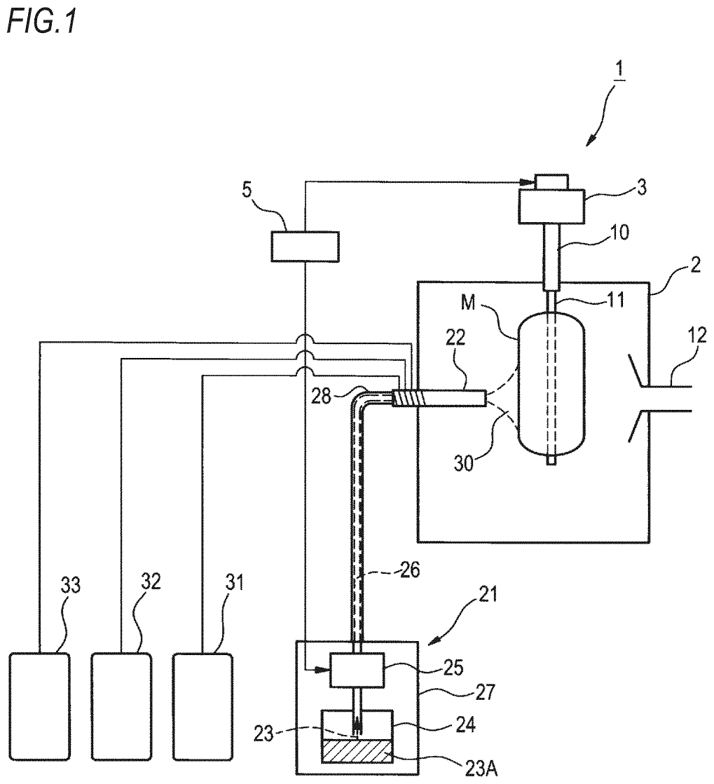

FIG. 1 is a configuration diagram of a device 1 for manufacturing a glass fine particle deposit of the embodiment (hereinafter, also referred to as a “glass fine particle deposit manufacturing device” or a “deposit manufacturing device”). The deposit manufacturing device 1 includes a reaction vessel 2, an elevating, lowering, and rotating device 3, a siloxane supply device 21, a carrier gas supply device 31, a seal gas supply device 32, a combustion gas supply device 33, a burner 22 for generating a glass fine particle, and a control unit 5 for controlling an operation of each unit.

The reaction vessel 2 is a vessel in which a glass fine particle deposit M is formed, and includes an exhaust pipe 12 attached to a side surface of the vessel.

The elevating, lowering, and rotating device 3 is a device for performing an operation of elevating and lowering the glass fine particle deposit M, and performing an operation of rotating the glass fine particle deposit M via a support rod 10 and a starting rod 11. The elevating, lowering, and rotating device 3 elevates, lowers, and rotates the glass fine particle deposit M based upon a control signal transmitted from the control unit 5.

The support rod 10 is arranged by being inserted into a through hole formed on an upper wall of the reaction vessel 2, and the starting rod 11 is attached to one end portion of the support rod 10 arranged in the reaction vessel 2 (a lower end portion in FIG. 1). The other end portion thereof (an upper end portion in FIG. 1) is gripped by the elevating, lowering, and rotating device 3.

The starting rod 11 is a rod on which the glass fine particle is deposited, and is attached to the support rod 10.

The exhaust pipe 12 is a pipe that discharges the glass fine particle not adhering to the starting rod 11 and the glass fine particle deposit M to the outside of the reaction vessel 2.

A siloxane gas 23, a carrier gas, a seal gas, and a combustion gas are supplied to the burner 22.

As the siloxane gas 23, vaporized liquid siloxane 23A is supplied into the siloxane supply device 21.

The siloxane supply device 21 includes a vaporization vessel 24 that vaporizes the liquid siloxane 23A, a mass flow controller (MFC) 25 that controls a gas flow rate of the siloxane gas 23, a supply pipe 26 that guides the siloxane gas 23 to the burner 22, and a temperature control booth 27 that controls a temperature of the vaporization vessel 24, the MFC 25, and a part of the supply pipe 26.

The MFC 25 is a device that supplies the siloxane gas 23 to be emitted from the burner 22 to the burner 22 via the supply pipe 26. The MFC 25 controls a supply amount of the siloxane gas 23 supplied to the burner 22 based upon a control signal transmitted from the control unit 5.

The supply pipe 26 is a pipe that guides the siloxane gas 23 to the burner 22. In order to keep a temperature of the supply pipe 26 at a high temperature, it is desirable that a tape heater 28, which is a heat generating element, is wrapped around an outer periphery of the supply pipe 26 and a part of an outer periphery of the burner 22. When the tape heater 28 is energized, the supply pipe 26 and the burner 22 are heated, and a temperature of the siloxane gas 23 emitted from the burner 22 can be raised to a temperature suitable for vaporization. For example, when the liquid siloxane 23A is octamethylcyclotetrasiloxane (OMCTS), the temperature thereof may be raised to 175° C. to 200° C. higher than 175° C. which is a standard boiling point of OMCTS.

The burner 22 generates a glass fine particle 30 by oxidizing the siloxane gas 23 in a flame, and emits the generated glass fine particle 30 on the starting rod 11 to deposit the generated glass fine particle 30 thereon. As the burner 22 for emitting the siloxane gas 23 and the combustion gas, for example, a cylindrical-shaped multi-nozzle (an emission port) structure or a linear multi-nozzle structure is used.

The control unit 5 controls each operation of the elevating, lowering, and rotating device 3 and the siloxane supply device 21. The control unit 5 transmits a control signal for controlling an elevating and lowering speed of the glass fine particle deposit M and a rotating speed thereof to the elevating, lowering, and rotating device 3. The control unit 5 transmits a control signal for controlling a flow rate of the siloxane gas 23 to be emitted from the burner 22 to the MFC 25 of the siloxane supply device 21. The control unit 5 transmits control signals for controlling respective flow rates of the carrier gas, the seal gas, and the combustion gas to be emitted from the burner 22 to the carrier gas supply device 31, the seal gas supply device 32, and the combustion gas supply device 33, respectively.

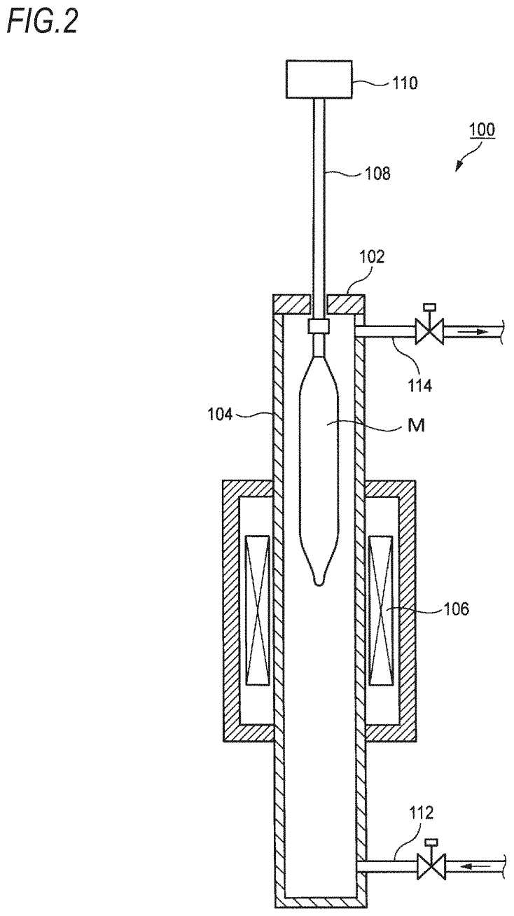

FIG. 2 is a configuration diagram of a device 100 (hereinafter also referred to as a “heating and sintering device”) that performs a transparency step of heating the glass fine particle deposit M manufactured in a deposition step and making the glass fine particle deposit M transparent, in the method for manufacturing the glass base material of the embodiment.

The heating and sintering device 100 includes a core pipe 104 including an upper lid 102 and a heating heater 106 arranged around a periphery of the core pipe 104.

The heating and sintering device 100 includes a support rod 108 for holding the glass fine particle deposit M at a lower end and inserting the glass fine particle deposit M into the core pipe 104, and an elevating, lowering, and rotating device 110 for lowering the glass fine particle deposit M while rotating the glass fine particle deposit M together with the support rod 108.

The heating and sintering device 100 includes a gas introduction pipe 112 for supplying an oxygen-containing gas and a He gas at a lower end of the core pipe 104, and an exhaust pipe 114 at an upper part of the core pipe 104.

Next, procedures of a method for manufacturing a glass fine particle deposit of the embodiment, setting of siloxane supply amount concentration, and a method for manufacturing a glass base material using the glass fine particle deposit will be described.

[Deposition Step]

The glass fine particle is deposited by an outside vapor deposition method (OVD method) to manufacture the glass fine particle deposit M. First, as illustrated in FIG. 1, the starting rod 11 and a part of the support rod 10 are housed in the reaction vessel 2 in a state where the support rod 10 is attached to the elevating, lowering, and rotating device 3 and the starting rod 11 is attached to the lower end portion of the support rod 10.

Continuously, the MFC 25 supplies the siloxane gas 23 which is the raw material to the burner 22 while controlling the supply amount thereof based upon the control signal transmitted from the control unit 5.

The siloxane gas 23, the carrier gas, the seal gas, and the combustion gas (a flame forming gas) are supplied to the burner 22. Here, the siloxane gas and the carrier gas are emitted from an emission port at the center of the burner 22, the seal gas is emitted from an emission port of an outside in a radial direction of the emission port of the siloxane gas and the carrier gas, and the combustion gas is emitted from an outside in a radial direction of the emission port of the seal gas.

The glass fine particle 30 is generated by oxidizing the siloxane gas 23 in a combustion gas flame.

Next, the burner 22 continuously deposits the glass fine particle 30 generated in the flame on the rotating, elevating, and lowering starting rod 11.

The elevating, lowering, and rotating device 3 elevates, lowers, and rotates the starting rod 11 and the glass fine particle deposit M deposited on the starting rod 11 based upon the control signal from the control unit 5.

The siloxane used as the glass raw material in the embodiment is not particularly limited, but an annular siloxane is desirable in that the annular siloxane is industrially easily available and easy to be stored and handled, and OMCTS is more desirable among the siloxanes.

The carrier gas and the seal gas used in the embodiment are not particularly limited as long as the carrier gas and the seal gas are inert gases, but a nitrogen gas is desirable considering low cost among a helium gas, an argon gas, and the nitrogen gas cited as an example thereof.

The combustion gas used in the embodiment is not particularly limited as long as the combustion gas can form a flame and contains oxygen for oxidizing siloxane, but an oxyhydrogen gas and a methane gas are desirable.

The OVD (outside vapor deposition) method is described as an example of the deposition step shown above, and the present disclosure is not limited to the OVD method. The present disclosure can also be applied to a method for depositing glass from the glass raw material by using oxidation reaction in the same manner as that of the OVD method such as, for example, a VAD (vapor-phase axial deposition) method, and a MMD (multiburner multilayer deposition) method.

[Setting of Siloxane Supply Amount Concentration]

As described above, the glass fine particle deposit M manufactured in the above-described deposition step may contain a black glass fine particle. As one of the causes of the generation of the black glass fine particle, as described above, it is speculated that the concentration of the supply amount of siloxane, which is the raw material for glass synthesis, is high. That is, when the concentration of siloxane becomes high, an amount of oxygen required for the oxidation reaction of glass fine particle formation is insufficient, and as a result, it is assumed that the insufficiently oxidized silicon oxide (SiOₓ, X<2) having a black color is generated.

Considering the above points, the generation of the black glass fine particle can be prevented by lowering the concentration of the supply amount of siloxane. Meanwhile, when the concentration of the supply amount of siloxane is lowered, the generation of the black glass fine particle can be prevented, but a synthetic yield of the glass fine particle becomes lowered so that efficiency of manufacturing the glass fine particle deposit M becomes lowered. In order to sufficiently secure the efficiency of manufacturing the glass fine particle deposit M, at least 30% of the synthetic yield of the glass fine particle is required.

Therefore, in the embodiment, it is possible to derive an appropriate concentration range of the supply amount of siloxane in which the generation of the black glass fine particle in the glass fine particle deposit M can be prevented, and the synthesis yield of the glass fine particle can also be sufficiently improved.

Specifically, volume concentration of a supply volume amount of the siloxane gas per unit time with respect to the sum of the supply volume amount of the siloxane gas per unit time and a supply volume amount of the carrier gas per unit time (C1); and volume concentration of the supply volume amount of the siloxane gas per unit time with respect to the sum of the supply volume amount of the siloxane gas per unit time, the supply volume amount of the carrier gas per unit time, and a supply volume amount of the seal gas per unit time (C2) are set as follows.

10.6 volume %<C1<20.0 volume %

5.8 volume %<C2<10.0 volume %

In the deposition step, since the supply amount of siloxane is generally controlled by the MFC 25 by mass per unit time [for example, g/min (kg/s in the case of SI unit)], it is necessary to convert the supply amount thereof into a volume amount per unit time. A specific method of the volume amount conversion is described as follows.

Siloxane supply volume amount per unit time=[(siloxane supply mass per unit time)/(molecular weight of siloxane to be used)]×22.4

In the embodiment, siloxane supply mass per unit time Q is expressed by g/min, and a siloxane supply volume amount per unit time Q is expressed by sim. [(siloxane supply mass per unit time)/(molecular weight of siloxane to be used)] indicates the number of moles of siloxane to be supplied. 22.4 is integrated into the calculated number of moles, thereby making it possible to be converted into the siloxane supply volume amount per unit time Q′ (slm).

In the case of using OMCTS as siloxane, since the molecular weight of OMCTS is 296.62, the number of OMCTS supply moles per unit time is calculated by dividing OMCTS supply mass per unit time by the molecular weight 296.62 of OMCTS, in the above conversion formula. Next, an OMCTS supply volume amount per unit time Q′ can be calculated by integrating 22.4 into the calculated number of moles of OMCTS.

In the technical field, it is common that the supply amounts of the carrier gas and the seal gas are also generally controlled by the volume amount per unit time (slm).

Based upon the above description, the volume concentration of the supply volume amount of the siloxane gas Q′ with respect to the sum of the supply volume amount of the siloxane gas Q′ and the supply volume amount of the carrier gas Y (C1, volume %); and the volume concentration of the supply volume amount of the siloxane gas with respect to the sum of the supply volume amount of the siloxane gas Q′, the supply volume amount of the carrier gas Y, and a supply volume amount of the seal gas Z (C2, volume %) are calculated by the following formula.

C1=[(supply volume amount of siloxane gas Q′)/{(supply volume amount of siloxane gas Q′)+(supply volume amount of carrier gas Y)}]×100

C2=[(supply volume amount of siloxane gas Q′)/{(supply volume amount of siloxane gas Q′)+(supply volume amount of carrier gas Y)+(supply volume amount of seal gas Z)}]×100

It is desirable that C1 and C2 are respectively set as follows: 10.6 volume %<C1<20.0 volume %, and 5.8 volume %<C2<10.0 volume %, which is proved by the following examination results.

Under the following conditions, C1 and C2 are appropriately changed to manufacture the glass fine particle deposit M, and a generation state of the black glass fine particle and the synthetic yield of the glass fine particle are observed.
supply mass of siloxane (OMCTS) Q: 5 to 50 g/min
supply volume amount of the carrier gas (nitrogen gas) Y: 3 to 15 slm
supply volume amount of the seal gas (nitrogen gas) Z: 3 to 15 slm
flow velocity of a mixed gas of the siloxane gas and the carrier gas at the emission port of the burner 5 to 50 m/s
supply volume amount of the combustion gas (the oxyhydrogen gas) and other manufacturing conditions are all the same

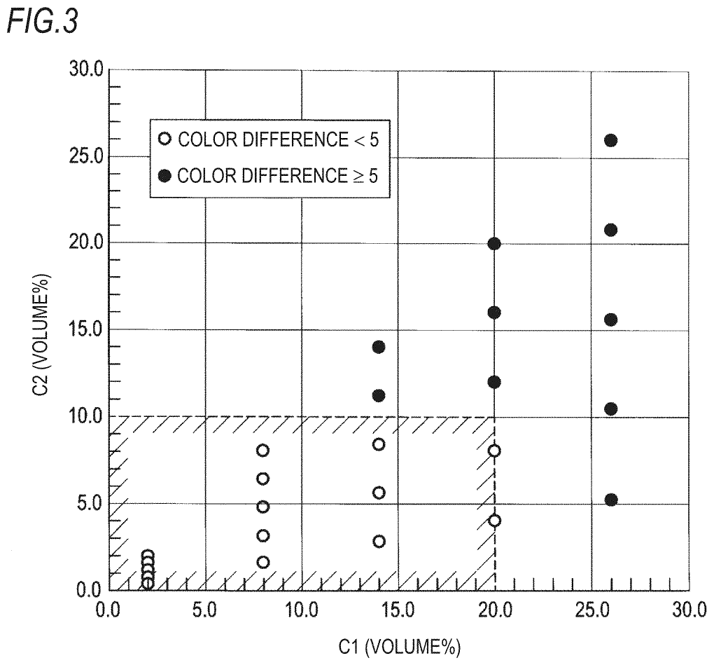

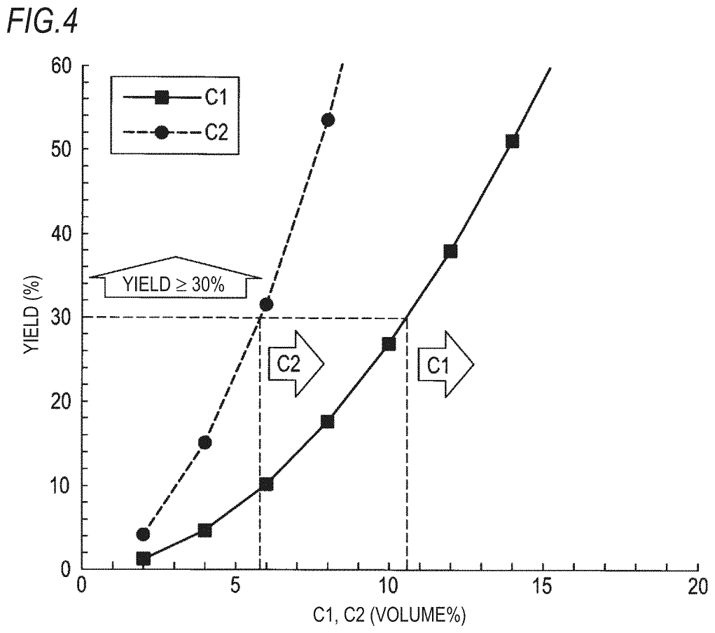

The above observation results are illustrated in FIGS. 3 and 4.

FIG. 3 is a graph showing a relationship between a numerical range of C1 and C2 and the generation state of the black glass fine particle. Specifically, in FIG. 3, the numerical range of C1 is shown on an X-axis, the numerical range of C2 is shown on a Y-axis, O indicates generation of a white glass fine particle, and [symbol] indicates the generation of the black glass fine particle. A difference between the white glass fine particle and the black glass fine particle is distinguished by a color difference ΔE*ab based upon a white color when a surface is measured by an SCI method with a spectrophotometer. A glass fine particle whose color difference ΔE*ab is less than 5 is defined as the white glass fine particle, and a glass fine particle whose color difference ΔE*ab is equal to or greater than 5 is defined as the black glass fine particle.

From FIG. 3, it can be seen that the generation of the black glass fine particle is prevented when C1 is less than 20.0 volume % and C2 is less than 10.0 volume %.

FIG. 4 is a graph showing a relationship between the numerical range of C1 and C2 and the synthetic yield of the glass fine particle. Specifically, in FIG. 4, the numerical range of C1 and C2 is shown on the X-axis, a numerical range of the synthetic yield of the glass fine particle is shown on the Y-axis, [symbol] indicates C1, and [symbol] indicates C2.

From FIG. 4, it can be seen that when C1 exceeds 10.6 volume % and C2 exceeds 5.8 volume %, the synthesis yield of the glass fine particle of 30% or more can be obtained.

The synthetic yield of the glass fine particle can be calculated from a weight of the inputted raw material and a weight of the deposited glass fine particle.

From the above description, it can be seen that under the condition of 10.6 volume %<C1<20.0 volume %, and 5.8 volume %<C2<10.0 volume %, the generation of the black glass fine particle can also be prevented, and the synthetic yield of the glass fine particle can also be sufficiently high at 30% or more.

The flow velocity of the mixed gas of the siloxane gas 23 and the carrier gas at the emission port of the burner 22 is desirably 5 to 50 m/s. Since the oxidation reaction time of siloxane is sufficient within the above-described flow velocity range, the generation of the black glass fine particle can be further prevented, and the synthesis yield of the glass fine particle can be further improved. The flow velocity of the mixed gas of the siloxane gas 23 and the carrier gas at the emission port of the burner 22 is a value obtained by dividing the sum of the supply volume amount of the siloxane gas per unit time and the supply volume amount of the carrier gas per unit time by a cross-sectional area of the emission port.

It is desirable that a synthesis rate of the glass fine particle is equal to or greater than 0.0000167 kg/s and equal to or less than 0.00067 kg/s (1.0 g/min or more and 40 g/min or less). Within the above-described synthesis rate range, the glass fine particle deposit can be manufactured with higher efficiency.

[Transparency Step]

The glass fine particle deposit M manufactured in the deposition step is dehydrated and sintered to make the glass transparent.

As illustrated in FIG. 2, an upper end portion of the starting rod 11 is fixed to a lower portion of the support rod 108, and is suspended and supported at the lower portion thereof to be movable in a vertical direction by the elevating and lowering device 109, such that the glass fine particle deposit M can be inputted into the device 100.

In the device 100, a mixed gas of a chlorine gas (Cl₂) and the helium gas (He) is introduced into the core pipe 104 from the gas introduction pipe 112. A temperature inside the core pipe 104 is maintained within a temperature range of 1000° C. to 1350° C. (desirably 1100° C. to 1250° C.), and the glass fine particle deposit M is moved downward at a predetermined speed. When the glass fine particle deposit M reaches a final lower end position, a dehydration treatment is temporarily completed.

Next, the glass fine particle deposit M is pulled upward and returned to a starting position. The temperature inside the core pipe is raised to 1400° C. to 1600° C., and at the same time, the chlorine gas (Cl₂) and the helium gas (He) of a specific ratio or only the helium gas (He) are or is introduced from the gas introduction pipe 112. The glass fine particle deposit M is moved downward again at a predetermined speed, and at the point of time when the glass fine particle deposit M reaches the final lower end position, the glass transparency is completed and the glass base material is obtained. The obtained glass base material has significantly less voids.

The embodiment disclosed herein should be considered as example in all respects, and should not be limited thereto. The scope of the present invention is indicated not by the above-described meaning but by the scope of the claims, and is intended to include all modifications within the meaning equivalent to the scope of the claims and the scope thereof.

### REFERENCE SIGNS LIST

1: deposit manufacturing device
2: reaction vessel
3: elevating, lowering, and rotating device
5: control unit
10: support rod
11: starting rod
12: exhaust pipe
21: siloxane supply device
22: burner
23: siloxane gas
23A: liquid siloxane
24: vaporization vessel
25: MFC
26: supply pipe
27: temperature control booth
28: tape heater
30: glass fine particle
31: carrier gas supply device
32: seal gas supply device
33: combustion gas supply device
100: heating and sintering device
102: upper lid
104: core pipe
106: heating heater
108: support rod
110: elevating, lowering, and rotating device
112: gas introduction pipe
114: exhaust pipe
M: glass fine particle deposit

1: A method for manufacturing a glass fine particle deposit,
installing a starting rod and a burner for generating a glass fine particle in a reaction vessel;
introducing a siloxane gas which is a glass raw material into the burner;
generating the glass fine particle by oxidizing the glass raw material in a flame formed by the burner;
depositing the generated glass fine particle on the starting rod;
emitting the siloxane gas and a carrier gas from a center of the burner;
emitting a seal gas from an outside in a radial direction of an emission port of the siloxane gas and the carrier gas;
emitting a combustion gas from an outside in a radial direction of an emission port of the seal gas;
setting volume concentration of a supply volume amount of the siloxane gas per unit time with respect to the sum of the supply volume amount of the siloxane gas per unit time and a supply volume amount of the carrier gas per unit time (C1) to 10.6 volume %<C1<20.0 volume %; and
setting volume concentration of the supply volume amount of the siloxane gas per unit time with respect to the sum of the supply volume amount of the siloxane gas per unit time, the supply volume amount of the carrier gas per unit time, and a supply volume amount of the seal gas per unit time (C2) to 5.8 volume %<C2<10.0 volume %.

2: The method for manufacturing the glass fine particle deposit according to claim 1,
wherein a flow velocity of a mixed gas of the siloxane gas and the carrier gas at the emission port of the burner is set to be equal to or higher than 5 m/s and equal to or lower than 50 m/s.

3: The method for manufacturing the glass fine particle deposit according to claim 1,
wherein a synthesis rate of the glass fine particle is equal to or greater than 0.0000167 kg/s and equal to or less than 0.00067 kg/s, and
wherein a synthesis yield of the glass fine particle is equal to or greater than 30%.

4: A method for manufacturing a glass base material, the method comprising heating and sintering a glass fine particle deposit manufactured by the method according to claim 1.
